(19) United States
(12) Patent Application Publication
(10) Pub. No.: US 2005/0120826 A1
(43) Pub. Date: Jun. 9, 2005

(54) Method of fabricating hollow spheres, hollow spheres obtained thereby, and a sound absorber device making use thereof

(75) Inventors: Osmin Delverdier, St Jean Lherm (FR); Philippe Vie, Toulouse (FR)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: ATECA, Montauban (FR)

(21) Appl. No.: 10/994,190

(22) Filed: Nov. 19, 2004

(30) Foreign Application Priority Data
Nov. 21, 2003 (FR) 03 13684

(51) Int. Cl. B29C 67/20

(52) U.S. Cl. 75/332; 264/236; 264/317; 264/41; 264/400; 264/154

(57) ABSTRACT

A method of fabricating hollow spheres that involve cores in a mixer are covered by a polymeric binder; a first powder material is prepared in the form of an organic powder or a metal or mineral powder or fibers, and a second powder material that is can be decomposed by heat and/or that is soluble in a solvent; said powder materials are mixed together and added into the mixer; the resulting coated cores are dried; the coated cores are baking to destroy the cores and the second powder material, and to cross-link the binder so as to obtain hollow spheres with walls that are porous and perforated; optionally the spheres are immersed in a solvent; and said hollow spheres are subjected to mechanical piercing. Hollow spheres, and a sound-absorber device making use of them.

### CROSS-REFERENCE TO RELATED APPLICATON

This application claims the benefit of priority under 35 U.S.C. § 119 to co-pending French Application Serial No. 03 13684, filed Nov. 21, 2003, which is incorporated herein by reference in its entirety.

### FIELD OF THE INVENTION

The invention relates to the field of sound-absorber devices, and in particular to fabricating hollow spheres that constitute the absorbent medium of such devices.

### BACKGROUND OF THE INVENTION

Sound-absorber devices using hollow spheres of metal, ceramic, or polymer are already known. The spheres may merely be placed in a receptacle having perforated walls situated facing the source of the sound that is to be absorbed. The spheres may also be stuck or bonded to one another to form a layer or a set of layers, which layer(s) is/are optionally secured to a perforated panel or between two perforated panels. The spheres can also be incorporated in a honeycomb structure. Such devices are described, for example, in documents FR-A-2 778 780, JP-A-53 125 462, FR-A-2 775 216. They are applied in particular in the aerospace industry for soundproofing jets and engines.

Document U.S. Pat. No. 5,777,947 proposes using hollow spheres of metal or ceramic having a diameter of less than 100 millimeters (mm), and presenting on their surfaces one or more perforations having a diameter of 50 micrometers (μm) to 500 μm. Compared with non-perforated spheres, and other things remaining equal, the use of perforated spheres makes it possible to propose soundproofing panels having their best absorption frequencies shifted downwards. In addition, absorbing sound over the entire audible spectrum is improved as a whole and made more uniform. However, that document gives no details about how to make such perforated spheres. In addition, that document envisages using such spheres only when placed loosely in a perforated receptacle.

### SUMMARY OF THE INVENTION

The invention is directed to a method that is simple and inexpensive for obtaining hollow spheres with perforated surfaces, that are of good performance and suitable in particular for use in sound-absorber devices in a variety of configurations.

The invention provides a method of fabricating hollow spheres suitable for use in sound-absorber devices, the method comprising steps or acts of preparing cores of material that melts or decomposes when heated, of dimensions corresponding to the dimensions of the space inside the spheres that are to be fabricated; placing the cores in a mixer and covering them therein with a liquid binder based on polymeric compounds suitable for cross-linking under the effect of temperature; preparing a first powder material in the form of an organic powder or of a metal or mineral powder or of fibers; preparing a second powder material that is decomposable by heat and/or soluble in a solvent in which the first powder material and the binder are not soluble; mixing said first and second powder materials together and adding them into the mixer; drying the resulting coated cores; baking the coated cores at a temperature that causes the material constituting the cores to melt or decompose, possibly together with the second powder material, and causing the polymeric compounds of the binder to cross-link so as to obtain hollow spheres having porous and perforated walls; optionally immersing the hollow spheres with porous and perforated walls in a solvent in which the cross-linked binder and the first powder material are insoluble; and performing an operation of mechanically piercing said hollow spheres.

The first powder material may be a metal or mineral powder or fibers. The temperature at which the cores are baked can cause the first powder material to sinter.

The mechanical piercing may be performed by laser piercing.

The mechanical piercing may be performed by sand-blasting.

A plurality of cycles may be performed for coating the cores in said first and second powder materials.

The material constituting the core may be selected from expanded polystyrene, ABS, and thermoplastic polymers.

The material constituting the binder may be selected from a resin and an organic adhesive.

The first powder material may be selected from a sinterable metal powder and a mineral powder or mineral fibers suitable for forming a ceramic by sintering.

The first powder material may be an organic powder.

The organic powder may be selected from an epoxy resin and a thermosetting polymer.

The second powder material may be selected from wood, a plastics material, cellulose, expanded polystyrene, cork, and a salt that is soluble in water such as sodium chloride.

During the mechanical piercing operation, the spheres may be placed in a slab provided with grooves facing the means for performing the piercing.

The invention also provides hollow spheres suitable for use in sound-absorber devices, the spheres being obtained by the above method.

The invention also provides a sound-absorber device of the type using hollow spheres, wherein said spheres are of the above type.

As will have been understood, the method of the invention can involve creating pores and perforations in the surface of hollow spheres in two ways in combination. Firstly, materials are typically included amongst the initial components used for fabricating the spheres, which materials can subsequently be destroyed during heating or dissolved by a solvent. Secondly, typically after the spheres have been obtained, a mechanical piercing operation can be performed on them, e.g. by sand-blasting or utilizing a laser beam. Spheres are thus obtained that present walls that are perforated with several types of perforation, giving greater latitude to the manufacturer of the sound-absorber device to optimize the performance of the device in terms of absorption intensity over the entire spectrum and/or over preferred frequency ranges.

In general, the perforations obtained by destroying or dissolving compounds (a physico-chemical method) are generally of diameters that are distributed in Gaussian manner about a value that may lie in the range 10 μm to 200 μm. The perforations that are obtained mechanically are typically of diameters of the order of 200 μm to 600 μm, and are more regular and uniform in dimension than the other perforations.

### BRIEF DESCRIPTION OF THE DRAWINGS

The invention will be better understood on reading the following description given with reference to the following accompanying figures:

FIG. 1 shows the wall of a sphere of the invention during fabrication, prior to the mechanical piercing operation and as seen from above (FIG. 1a) and in section (FIG. 1b);

FIG. 2 shows spheres of the invention in their final state, one being made of sintered ceramic, and the other of polymer; and

FIG. 3 shows in a cross-section and perspective view (FIG. 3a) and in a plan view (FIG. 3b) an example of a device adapted to hold the spheres while performing the mechanical piercing operation.

### DETAILED DESCRIPTION

Initially, parts referred to as “cores” are prepared, which cores are spheres of diameter corresponding substantially to the inside diameter of the hollow spheres that are to be obtained. It should be understood that the term “spheres” is used to designate volumes of a shape that need not be accurately spherical. They may be elliptical in section, or more or less irregular in shape. In general, any shape making the fabricated articles suitable for constituting a material for lining sound-absorber panels is acceptable.

The cores may be made of a material that is suitable for melting or decomposing at a relatively low temperature, a temperature at which the material constituting the spheres is capable of remaining without itself being destroyed while being subjected to modifications to its morphology (cross-linking and possibly sintering) that produce its final state. As examples of such materials for constituting the cores, mention can be made of expanded polystyrene, polyethylene, acrylonitrile-butadiene-styrene copolymer (ABS), and other thermoplastic polymers. In the detailed example described below, the cores have a diameter of about 2 mm.

The cores are typically introduced into a mixer, i.e. a receptacle turning about its own axis at a speed of about 35 revolutions per minute (rpm) for example.

A liquid binder is prepared based on a resin or organic adhesive (e.g. epoxy resin or polyvinyl alcohol). With a resin, typically 40 grams (g) of resin is prepared per liter (L) of cores. With an adhesive, typically 70 g of adhesive is prepared per liter of cores.

A first powder material can also be prepared, formed by the material that is to constitute the spheres. This material may be a metal powder (e.g. nickel or steel), optionally a sinterable powder, or a mineral (e.g. alumina, talc) or mineral fibers (e.g. glass, wollastonite), and the mineral compounds may be suitable for forming a ceramic by sintering. It may also be constituted by an organic powder, such as a ground epoxy powder or a thermosetting polymer.

Depending on the nature of the material, its quantity lies in the range 100 g to 200 g per liter of cores for fibers. Preferably, the grain size of these materials is of the order of a few micrometers: typically 12 μm to 50 μm for powders, and 100 μm diameter and 300 μm length for fibers.

A second powder material can also be prepared, possibly constituted by:
a powder, e.g. of wood or of plastics material (30 g to 50 g per liter of cores);
or fibers, e.g. cellulose fibers (250 g to 350 g per liter of cores);
or a granular material, e.g. expanded polystyrene, cork (30 g to 50 g per liter of cores), or a salt that is soluble in water such as sodium chloride.

The grain size of this second powder material can be of the order of 100 μm to 400 μm and can be selected by screening. The material which constitutes it should have the property of being destroyed by heating to a temperature which does not destroy the first powder material and/or of being dissolved by a solvent to which the first powder material and the binder are insensitive. From this point of view, the use of grains of sodium chloride is advantageous: in addition to its low cost, this material has the advantage of being soluble in water, which can therefore constitute said solvent. In general, any water-soluble salt is suitable for this purpose. Advantageously, the diameter of the particles or the length of the fibers of the second powder material should be greater than or equal to the wall thickness of the spheres that are to be obtained, which thickness is itself defined in particular by the quantities of binder and first powder material used relative to the total surface area of the cores.

It will be understood that the first powder material, together with the binder, can serve to constitute the material of the spheres. It can also govern the surface state and the morphology of the spheres. The second powder material, which is typically to be destroyed during the process, can serve to create perforations or pores in the surface of the spheres. Perforations can be created in particular with the help of those particles and fibers of the second powder material which are of a dimension greater than the thickness of the walls of the spheres.

The first and second powder materials are typically mixed in a small drum in uniform manner.

While the mixer containing the cores is rotating, the resin- or adhesive-based liquid binder is typically poured in slowly. The mixer is allowed to continue turning until the cores are uniformly covered by the liquid.

Once this condition has been achieved, the mixture of powder materials can be introduced into the mixer. This introduction should be carried out very progressively so as to avoid the powder materials forming lumps inside the mixer.

It is recommended to perform this introduction in stages of 5% of the total volume of the powder materials, these stages themselves can be added slowly. Once the entire powder mixture has been added, the mixer is typically allowed to continue rotating for 30 seconds (s) to 3 minutes (min) depending on the types of liquid and powder used.

The cores coated in this way can then be extracted from the mixer and set to dry in a stream of hot air (up to a maximum temperature of 50° C.). After drying, if it is desired to obtain spheres having relatively thick walls, the coated cores can be put back into the mixer and a new coating cycle can be started. A coating cycle of the kind described above leads to a wall thickness of about 0.15 mm to 0.2 mm.

Once the desired coating thickness has been obtained, the coated cores are typically baked at a temperature that can melt or decompose the cores; cross-link the polymer components of the binder, and possibly also to sinter the metal or ceramic powders that are present, if any, so as to consolidate the coating of the cores and thus make it suitable for constituting the outside surfaces of the spheres; and optionally eliminating the second powder material; such elimination typically has the effect of forming pores and micro- and macro-perforations in the walls of the spheres, thereby facilitating removal from the spheres of the material constituting the cores in the molten or gaseous state.

If necessary, the operation can be finished off by immersing the spheres in a solvent such as acetone or water in order to eliminate the second powder materials if that does not take place during baking, and in general in order to eliminate the last traces of various compounds that might be dissolved by the solvent and that are not desired in the spheres. Naturally, the solvent should not affect the binder and the sintered or non-sintered powders or fibers that are to constitute the final material of the hollow spheres. If a water-soluble salt is used as the second powder material, the use of water as the solvent is particularly appropriate.

At this stage, hollow spheres can be obtained having a diameter that lies typically in the range 1 mm to 7 mm, and that is about 2 mm in the above example, with surface perforations and pores of dimensions of the order of a few micrometers to several hundreds of micrometers. These perforations and pores may be cylindrical or elongate. The perforations do not necessarily follow paths that are perpendicular to the wall, they may be oblique or tortuous. The perforations are typically distributed randomly, and the number of perforations is typically proportional to the quantity of second powder material used.

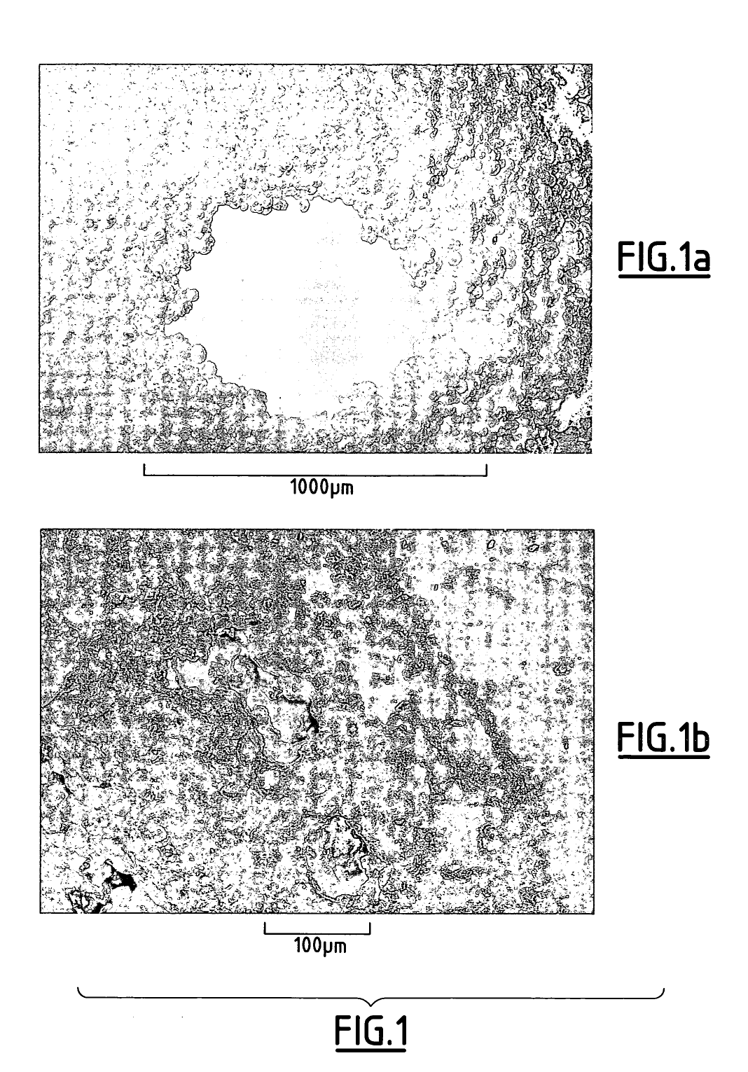

FIG. 1a is a micrograph showing the surface of a hollow sphere at this stage of fabrication. The sphere is essentially made of ceramic (sintered alumina). It was obtained from a binder constituted by polyvinyl alcohol, a first powder material constituted by alumina powder having a grain size of 8 μm, and a second powder material constituted by cellulose having a grain size of 300 μm to 600 μm. Baking took place at 1650° C. to cause the binder to cross-link and the alumina to sinter. FIG. 1a shows a wall perforation having a diameter of about 1 mm. FIG. 1b is a section made through the wall of the same hollow sphere, and it shows the pores that are present inside the wall, and also at the surface. The size of these pores can be up to about 100 μm. Some of the pores enable tortuous microperforations to be created that pass through the wall of the sphere.

Thereafter, additional perforations can be made in the walls of the spheres by mechanical means. For this purpose, it is possible to use a laser piercing method, a sand-blasting method using microbeads (e.g. made of ceramic, of metal, or of glass) having a grain size corresponding to the diameter of the desired perforations, or both types of method can be used in succession. It is also possible to perform piercing by means of needles.

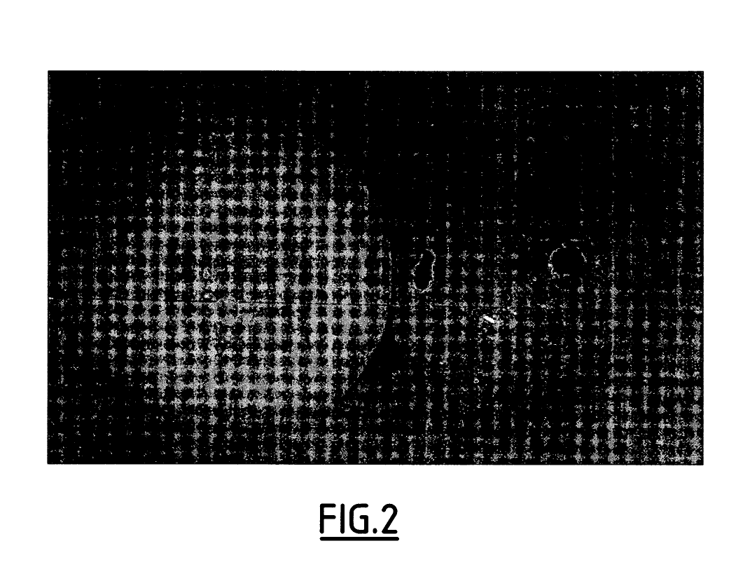

Exemplary hollow spheres of the invention shown in FIG. 2 are:
on the left, a sphere of sintered alumina having a diameter of 4 mm, and having two perforations that are 0.25 mm in diameter (only one is visible in the figure), the perforations being made by laser piercing; and
on the right, a cross-linked polymer sphere with a diameter of 2.5 mm, in which the binder is an epoxy resin, the first powder material is wollastonite fiber, and the second powder material was polyamide powder; it has four perforations with a diameter of 0.48 mm (two of which are visible in the figure) obtained by laser piercing.

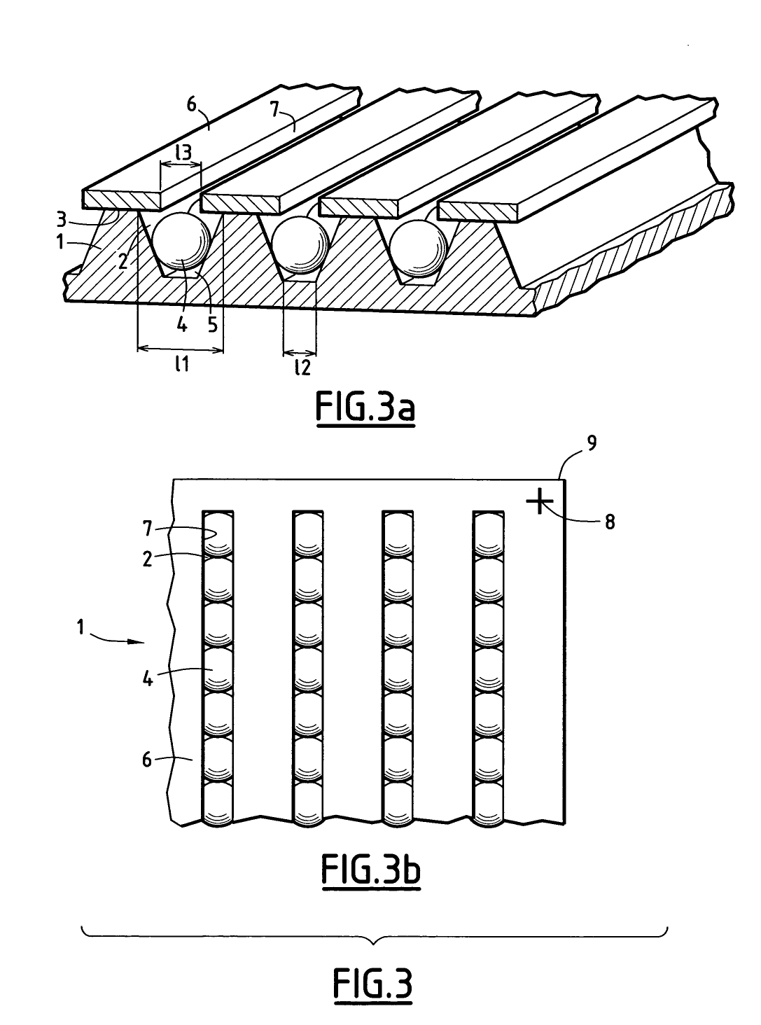

During this piercing operation, the spheres are preferably placed in a container enabling them to be held steady facing the means for performing the piercing, e.g. facing the needles or the source of laser radiation or the microbeads. For this purpose, it is possible to use a device of the kind shown diagrammatically in FIG. 3. It can comprise a plane slab 1 having grooves 2 formed therein that are open out into the top face 3 of the slab 1 and that flare towards said top face. These grooves 2 can, for example, have a maximum width l1 that is greater than the diameter of the spheres 4 which are placed therein, and a minimum width l2 that is less than said diameter, so that a gap 5 is left beneath the spheres 4. The depth of the grooves 2 is such that the spheres are typically fully contained therein and do not project beyond the top face 3 of the slab 1. The grooves 2 may be partially obstructed by a cover 6 placed on the top face 3 of the slab 1 and provided with openings 7 that are situated in register with the grooves 2 when the cover 6 is in place. The openings 7 are typically of a width l3 that is less than l1, and less than the diameter of the spheres 4 so as to ensure that the spheres 4 are held in the grooves 2. Advantageously, the cover 6 can be permanently secured to the slab 1 and can be put into place by pivoting about an axis 8 located close to a corner 9 of the slab 1.

The spheres 4 can be pierced by bringing the slab 1 containing the spheres 4 so as to face one or more sources of microbeads, for example. The assembly may be stationary, in which case it is the beam(s) of microbeads that should be capable of covering the entire surface of the openings 7 simultaneously. It is also possible to establish relative movement between the slab 1 and the source(s) of microbeads so as to minimize the number of sources of microbeads and the areas onto which they are projected.

The microbeads which have perforated the spheres 4 can accumulate in the space 5 and can be recovered at the end of the operation, or while it is in progress.

With laser piercing, the laser source is typically brought to face the sphere for piercing, or vice versa, with piercing taking place “on the fly”, e.g. at a rate of 10 holes per second, which holes pass right through a sphere.

Whether piercing by sanding or piercing by laser is selected depends on the material constituting the spheres, and on the morphology of the perforations that are to be obtained. Laser piercing can be more suitable for stronger materials. It can also present the advantage of enabling through perforations to be made easily and quickly, i.e. to make two perforations in a single operation, and experience shows that it may be advantageous for the spheres to have at least two perforations. Under such conditions, head loss may be created, thereby dissipating waved energy when a soundwave passes through the sphere.

The perforations that result from mechanical piercing are typically in the form of cylindrical holes having a diameter that generally lies in the range about 0.2 mm to 1 mm.

As mentioned above, when the first powder material is a metal or a mineral, it is possible not only to cause the binder to cross-link, but also to sinter the metal or mineral particles or fibers. Whether sintering occurs depends on the temperature at which the spheres are placed. A high baking temperature and a large content of first powder material enables spheres to be obtained having walls that are made up for the most part out of metal or ceramic in the sintered state. If sintering is not performed, typically because baking takes place at too low a temperature, then the particles and fibers can behave like mineral fillers which contribute together with the binder to consolidating the surfaces of the spheres. This applies to the right-hand sphere in FIG. 2.

After the spheres have been made by the method of the invention, they can be used to form sound-absorber devices, being implemented therein using known methods.

### EXAMPLE

A comparison has been made between the results obtained with stacks of spheres in bulk, the spheres having a diameter of 1.5 mm, and the comparisons concerning flow resistance, tortuosity, and porosity. In the reference test, the spheres were solid and not perforated. In the test relating to spheres of the invention, they were hollow spheres of ceramic material, with the perforations that had been obtained physico-chemically having diameters in the range 20 μm to 400 μm, and with the perforations that had been obtained mechanically having a diameter of 500 μm. The wall thickness was 0.3 mm.

The results are summarized in Table 1.

TABLE 1
Characteristics of stacks of spheres

| | Flow resistance (Pa · s) | Tortuosity | Porosity |
|---|---|---|---|
| Reference | 13,600 | 3.36 | 40 |
| Invention | 15,800 | 3.92 | 80 |

Flow resistance typically represents the head loss suffered by a flow of air passing through the stack. It associates the pressure difference between inlet and outlet and the speed of the flow, and in the present case it can explain the acoustic resistance of the material. It depends on tortuosity and on porosity. It can be seen that the spheres of the invention as tested obtained an increase of 16% for flow resistance compared with the reference spheres.

Tortuosity is typically an index representative of the path traveled by a wave in order to pass through the material. The greater the tortuosity, the better the sound dissipation in the material. The stack of spheres of the present invention present tortuosity that is significantly higher than the stack of reference spheres.

Porosity typically represents the ratio between the empty volume generated by the spheres and the total volume of the dissipating layer. A stack of spheres in bulk that are solid or hollow but without perforations provides porosity of only 40%. The micro- and macro-perforations enable the insides of the spheres to participate in the physical phenomenon involved (wave dissipation). It can be seen that porosity is increased considerably when using macro- and micro-perforated spheres made by the method of the invention.

The influence on porosity of the number of perforations obtained by mechanical piercing has also been studied. A comparison was thus made between the porosity of stacks of hollow ceramic spheres in bulk, the spheres having a diameter of 2 mm and a wall thickness of 0.4 mm, being made by the method of the invention, and with the number of perforations of 0.3 mm formed therein by laser piercing being varied. The results are summarized in Table 2.

TABLE 2
Influence of the number of mechanical perforations in the spheres on
the porosity of a stack

| Number of mechanical | Porosity |
|---|---|
| perforations (laser) | (%) |
| 2 | 81 |
| 4 | 83 |
| 6 | 85 |
| 8 | 90 |

The hollow spheres obtained in this way can be used in the conventional manner in sound-absorber devices in the form of superposed layers or in a single layer, or in bulk stack within a supporting structure.

1-14. (canceled)

15. A method of fabricating hollow spheres suitable for use in sound-absorber devices, the method comprising:
preparing cores of material that melts or decomposes when heated;
placing the cores in a mixer and covering them therein with a liquid binder based on polymeric compounds suitable for cross-linking under the effect of temperature;
preparing a first powder material in the form of an organic powder or of a metal or mineral powder or of fibers;
preparing a second powder material that is decomposable by heat and/or soluble in a solvent in which the first powder material and the binder are not soluble;
mixing said first and second powder materials and adding them into the mixer;
drying the resulting coated cores; and
baking the coated cores at a temperature that causes the material constituting the cores to melt or decompose, causing the polymeric compounds of the binder to cross-link so as to obtain hollow spheres having porous and perforated walls.

16. The method of claim 15, further comprising immersing the hollow spheres in a solvent.

17. The method of claim 1, further comprising mechanically piercing the hollow spheres.

18. The method according to claim 15, wherein the first powder material is a metal or mineral powder or fibers, and wherein the temperature at which the cores are baked causes the first powder material to sinter.

19. The method according to claim 17, wherein the mechanical piercing is performed by laser piercing.

20. The method according to claim 17, wherein the mechanical piercing is performed by sand-blasting.

21. The method according to claim 1, wherein a plurality of cycles are performed for coating the cores in said first and second powder materials.

22. The method according to claim 15, wherein the material constituting the core is selected from expanded polystyrene, ABS, and thermoplastic polymers.

23. The method according to claim 15, wherein the material constituting the binder is selected from the group consisting of a resin and an organic adhesive.

24. The method according to claim 15, wherein the first powder material is a sinterable metal powder and a mineral powder or mineral fibers suitable for forming a ceramic by sintering.

25. The method according to claim 15, wherein the first powder material is an organic powder.

26. The method according to claim 24, wherein the organic powder is selected from the group consisting of an epoxy resin and a thermosetting polymer.

27. The method according to claim 15, wherein the second powder material is selected from the group consisting of wood, a plastics material, cellulose, expanded polystyrene, and cork.

28. The method according to claim 17, wherein, during the mechanical piercing operation, the spheres are placed in a slab provided with grooves.

29. A hollow sphere suitable for use in sound-absorber devices, the spheres being obtained by the method according to claim 15.

30. A sound-absorber device of the type using hollow spheres, wherein said spheres are of the type according to claim 29.
